(19) United States
(12) Patent Application Publication
(10) Pub. No.: US 2026/0189372 A1
(43) Pub. Date: Jul. 2, 2026

(54) DEVICE, METHOD AND SYSTEM FOR COMMUNICATION BETWEEN DEVICES IN THE ABSENCE OF TIME SYNCHRONIZATION

(71) Applicant: MOTOROLA SOLUTIONS, INC., Chicago, IL (US)

(72) Inventors: Ramu Kandula, Oak Point, TX (US); Rajendra Anthony, Richardson, TX (US); Madhusudan Upendra Krishna Pai, Frisco, TX (US); Ayush Jain, MuzaffarNagar (IN)

(21) Appl. No.: 19/005,140

(22) Filed: Dec. 30, 2024

(51) Int. Cl. H04L 9/08; G06F 1/10

(52) U.S. Cl. CPC H04L 9/0847; G06F 1/10; H04L 9/0825

(57) ABSTRACT

A method, system, and device for secure communication in environments without synchronized clocks. Using a clock-skew server, devices embed clock-skew certificates in MIKEY-SAKKE messages to compute and verify message generation times. These certificates facilitate secure message exchange, including peer-to-peer scenarios and applications requiring intermediary servers, by addressing clock drift without relying on external time references. Embodiments support mission-critical communication while mitigating replay attacks and resource inefficiencies inherent in traditional synchronization-dependent methods.

### BACKGROUND

Secure communication protocols, such as MIKEY-SAKKE, use time synchronization to validate message integrity and defend against replay attacks. However, many operational environments, including those involving first responders, face challenges when devices lack access to centralized time references, such as NTP servers. This lack of synchronization leads to clock drift, disrupting secure communication and rendering protocols like MIKEY-SAKKE ineffective. Current solutions, such as increased replay caches, are resource-intensive and impractical in critical scenarios.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a system for communication between devices in the absence of time synchronization, in accordance with some examples.

FIG. 2 is a device diagram showing a device structure of a client device for use in the system of FIG. 1 for controlling, in accordance with some examples.

FIG. 3 is a flowchart of a method for communication between devices in the absence of time synchronization, in accordance with some examples.

FIG. 4 shows the system of FIG. 1 illustrating the process of a client device obtaining a clock-skew certificate from a clock-skew server, as described in Block 304.

FIG. 5 is a sequence diagram showing the sequence of operations between a client device and a clock-skew server to calculate and retrieve clock-skew values, in accordance with some examples.

FIG. 6 shows the system of FIG. 1 according to a first use case, where a client device sends a MIKEY-SAKKE i-message to an application server, incorporating clock-skew values for message validation.

FIG. 7 illustrates a sequence diagram corresponding to the first use case in FIG. 6, detailing the validation and processing of clock-skew-embedded MIKEY-SAKKE messages at the application server.

FIG. 8 shows a second use case, where an application server sends a MIKEY-SAKKE i-message to a client device using clock-skew corrections for secure communication.

FIG. 9 is shows the system of FIG. 1 depicting a third use case where a client device sends a MIKEY-SAKKE i-message to another client device via an application server.

FIG. 10 illustrates a sequence diagram for the third use case, including forwarding and validating clock-skew information at both intermediary and recipient devices.

FIG. 11 shows the system of FIG. 1 including a peer-to-peer communication setup for a fourth use case, highlighting devices communicating without application server involvement.

FIG. 12 depicts a sequence diagram for the fourth use case, where a client device directly communicates with another client device in a peer-to-peer mode using clock-skew certificates.

FIG. 13 shows a variant system configuration, where a client device integrates a clock-skew server for peer-to-peer communication, reducing dependency on centralized servers.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

A significant technical challenge arises in secure communication between devices, such as a first responder's radio, particularly in environments where message integrity and replay protection are critical. For example, MIKEY-SAKKE is an Identity-Based Encryption (IBE) protocol designed for secure, simplex transmission of session key information between two endpoints. The protocol can achieve security even in the presence of zero (peer-to-peer) or more intermediary network elements along the communication path. To safeguard the client devices from attacks,—such as replay attacks where a previously transmitted and intercepted MIKEY-SAKKE message is resent maliciously—the protocol utilizes synchronization of clocks at the devices and the maintenance of a replay message cache by the receiving endpoint client device. This cache can be used to detect and reject duplicate messages within a permissible time window.

In certain environments, the endpoint devices may not have their clocks synchronized to a common reference clock, such as a Network Time Protocol (NTP) server. Such an NTP server may be disallowed due to security concerns, or simply not available due to poor reception. This lack of synchronization may cause the clocks of the endpoint devices to drift beyond the permissible skew limit, leading to the rejection of valid MIKEY-SAKKE messages. Such rejection prevents the recipient device from extracting the session key embedded within the message, thereby interrupting the secure communication process. While one potential solution is to implement a replay message cache large enough to accommodate significant clock skew, this approach can be impractical and inefficient in scenarios where NTP or other clock synchronization mechanisms are unavailable. A large cache increases resource consumption, risks widening the attack surface, and may compromise the overall security and performance of the system.

This specification can address at least some these challenges by proposing an apparatus, method and system to securely handle clock skews in environments where messages (such as MIKEY-SAKKE messages) are transmitted between endpoint devices without relying on external clock synchronization. The specification introduces the concept of a clock-skew certificate generated by a trusted entity, such as a clock-skew server, which provides each endpoint with a verifiable clock-skew value. This clock-skew value can be embedded into the MIKEY-SAKKE message by the transmitting client device, so that the receiving client device can compute the time of generation of the message, even in the absence of external clock synchronization.

It has been observed that in many operational environments, particularly those involving mission critical communication systems such as nationwide or statewide public carrier networks, private cellular networks, wi-fi or wired networks. The same communication system may be deployed over multiple such networks at the same time. As such there may not be a single time source for all devices deployed in these one or more networks and as such, client devices may experience unsynchronized clocks with the server clock. This issue can result in the failure of key exchanges using MIKEY-SAKKE messages between a client device and the clock-skew server. Such failures disrupt secure communication and may lead to service outages, which are particularly problematic in emergency response or public safety contexts where reliability is paramount.

Additionally, this problem is not limited to communication between client devices and servers. It can also arise in peer-to-peer scenarios, such as private key transmission for one-to-one, end-to-end encrypted communication. In these cases, the lack of clock synchronization can exacerbate the difficulty in securely exchanging MIKEY-SAKKE messages.

An aspect of the specification provides a method including: receiving, at a first client device, a first clock-skew value from a clock-skew server; embedding the first clock-skew value in a first portion of a first electronic message having a defined-format; the first portion being different from a second portion of the first electronic message; the second portion including a payload; and, sending the electronic message to a recipient device that computes a time of generation of the electronic message based on the first clock-skew value and a second clock-skew value sent from the clock-skew server to the recipient device.

An aspect of the specification provides a method wherein the defined-format is the i_message format based on Multimedia Internet Keying-Sakai-Kasahara Key Encryption (MIKEY-SAKKE).

An aspect of the specification provides a method wherein the recipient device is one of an application server, a second client device, and the first client device.

An aspect of the specification provides a method further including, prior to sending, encrypting the first electronic message using at least one of a session key and a public/private key pair.

An aspect of the specification provides a method wherein the clock-skew server is remotely hosted from the first client device.

An aspect of the specification provides a method wherein the clock-skew server is a third client device and the method further including sending at least one additional defined-format electronic message embedding an additional clock-skew value generated by the third client device; the at least one additional defined-format electronic message being sent to one or more of the client devices.

An aspect of the specification provides a method wherein the clock-skew server is hosted within an application server domain remote to the first client device and the recipient device.

An aspect of the specification provides a method further including sending the electronic message to a third client device that computes the time of generation of the electronic message based on the first clock-skew value and a third clock-skew value sent from the clock-skew server to the third client device.

An aspect of the specification provides a method wherein the clock-skew server is integrated into to the first client device.

An aspect of the specification provides a method wherein the time of generation is used by the recipient device to determine a handling-protocol for the first electronic message.

An aspect of the specification provides a method wherein the handling protocol includes at least one of: a) detecting a replay attack and rejecting the first electronic message, and b) verifying that the first electronic message is valid.

An aspect of the specification provides a method wherein the receiving, embedding and sending occurs with call flows defined by the 3GPP standard.

An aspect of the specification provides a client device including a processor and a memory storing programming instructions that configure the processor to: receive a first clock-skew value from a clock-skew server; embed the first clock-skew value in a first portion of a first electronic message, the first portion being distinct from a second portion of the first electronic message, wherein the second portion includes a payload; and send the electronic message to a recipient device, wherein the recipient device is configured to compute a time of generation of the electronic message based on the first clock-skew value and a second clock-skew value received from the clock-skew server

An aspect of the specification provides a method wherein the defined-format is the i_message format based on Multimedia Internet Keying-Sakai-Kasahara Key Encryption (MIKEY-SAKKE).

An aspect of the specification provides a method wherein the recipient device is one of an application server, a second client device, and the first client device.

An aspect of the specification provides a method further including, prior to sending, encrypting the first electronic message using at least one of a session key and a public/private key pair.

An aspect of the specification provides a method of transmitting a cryptographic key securely from a first client device to a first recipient device using a first electronic message prepared by the first client device according to MIKEY-SAKKE identity based encryption scheme including: i) enabling, prior to transmitting the first electronic message, both the first client device and the first recipient device to cryptographically trust a clock skew service; ii) obtaining, prior to transmitting the first electronic message, a first clock skew certificate from the clock skew service by the first client device, the first clock skew certificate being cryptographically signed by the clock skew service and containing at least the identity of the first client device and a first clock-skew value representing the difference in time between the first client device and the clock-skew service; iii) obtaining, prior to transmitting the first electronic message, a second clock skew certificate from the clock skew service by the first recipient device, the second clock skew certificate being cryptographically signed by the clock skew service and containing at least the identity of the first recipient device, a second clock-skew value representing the difference in time between the first recipient device and the clock-skew service; iv) embedding, prior to transmitting the first electronic message, the first clock skew certificate into the first electronic message by the first client device along with a first timestamp representing the clock time within the first client device; v) receiving, by the first recipient device, the first electronic message transmitted by the first client device; vi) extracting the first clock-skew value from the first electronic message, by the first recipient, after cryptographically verifying the authenticity of the first clock skew certificate contained in the first electronic message; and vii) computing, by the first recipient device, the time of preparation of the first electronic message with reference to the clock time within the first recipient device, using the first clock-skew value, the second clock-skew value and the first timestamp

An aspect of the specification provides a method, wherein the first recipient device is a second client device having a substantially identical architecture to the first client device.

An aspect of the specification provides a method, wherein the first recipient device is an application server providing a service to the first client device.

An aspect of the specification provides a method, wherein the clock skew service is provided by a third client device having a substantially identical architecture to the first client device.

Each of the above-mentioned embodiments will be discussed in more detail below, starting with example system and device architectures of the system in which the embodiments may be practiced, followed by an illustration of processing blocks for achieving an improved technical method, device, and system for controlling alert transmission.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions and/or program code and/or computer program code. These computer program instructions and/or program code may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions and/or program code may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions and/or program code may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the drawings.

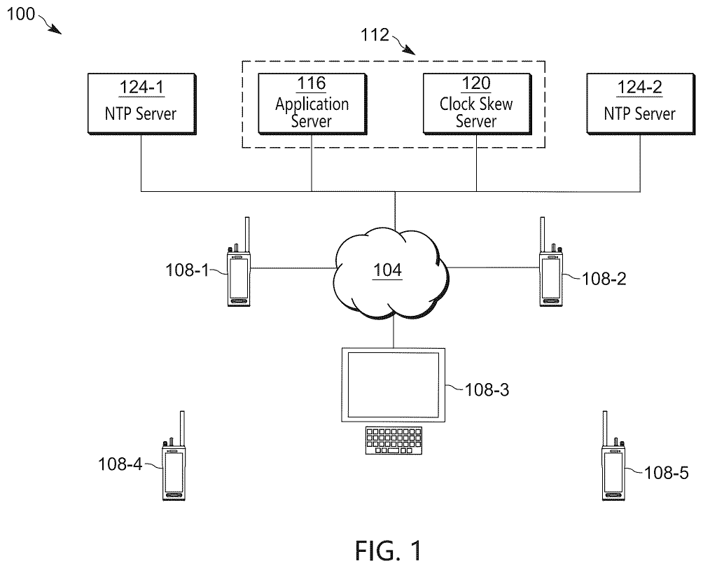

Attention is directed to FIG. 1, which depicts an example system 100 for communication between devices in the absence of time synchronization. As elaborated throughout, the various components of system 100 may be in communication via any suitable combination of wired and/or wireless communication links. As shown in FIG. 1, system 100 includes a network 104 which itself may be a combination of wired and/or wireless links, but which can interconnect one or more client devices 108, again, via wired links or wireless links. Note that in FIG. 1, five client devices 108-1, 108-2, 108-3, 108-4 and 108-5 are shown. (Collectively, these may be referred to as client devices 108 and generically as client device 108. This nomenclature is used elsewhere herein.).

As shown in in FIG. 1, devices 108-1, 108-2, 108-3 are shown connected to network 104. However, for illustrative purposes, devices 108-4, 108-5 are shown disconnected from network 104. It is to be understood, however, that all devices 108 may have states in which they are connected to network 104, or are disconnected from network 104. Furthermore, certain devices 108 may, from time-to-time, operate in a peer-to-peer mode, communicating directly with each other without any connection to network 104. Illustrative explanations about such connections, disconnections and peer-to-peer operation will be provided in further detail below.

Network 104 is also connected to an application domain 112, which is comprised of an application server 116 and clock skew server 120.

System 100 also optionally includes at least one Network Time Protocol (NTP) server 124 (or equivalent) that operates according to the known Network Time Protocol. The NTP server 124 receives accurate time from a Stratum zero source, such as an atomic clock or Global Positioning System (GPS) clock, and disseminates, where security restrictions permit, the time to client devices 108 or other servers, such as application server 116 and/or clock skew server 120 via network 104.

Devices 108 are adaptable for use in a wide range of scenarios and by various types of users. In a present embodiment, they are primarily utilized by first responders, such as police officers, firefighters, emergency medical technicians, and security personnel, among others. Each device 108 may include one or more input components, such as a microphone and/or a camera, which may either be integrated into the device or externally attached and communicatively coupled with the device. Additionally, devices 108 may incorporate output components, such as a display screen for visual information and/or an audio output device, such as a speaker, to facilitate auditory communication and alerts.

Devices 108-1, 108-2, 108-4, and 108-5 are illustrated as mobile client devices typically employed by first responders, such as police officers, firefighters, or paramedics. These mobile devices highlight the versatility of the system 100 in supporting on-the-go communication needs in various mission-critical scenarios. To further demonstrate the applicability of this specification across different operational environments, device 108-3 is depicted as a standalone terminal, such as a dispatch terminal, which may be operated by a dispatcher within a Public-Safety Answering Point (PSAP) or other type of dispatch center. Device 108-3 facilitates coordination and management of field operations by enabling the dispatcher to send alerts, assign resources, and relay incident information to first responders via their respective mobile client devices 108.

In a broader context, client devices 108 are not limited to the examples provided for first responders. Instead, client devices 108 can encompass a wide range of device types, including laptop computers, desktop computers, smartphones, tablets, or other network-enabled client devices. These devices may support various applications and functionalities, extending beyond first responder use cases to other professional, industrial, and general communication environments.

Additionally, it is to be understood that in certain embodiments, client devices 108 may be associated with a single organizational entity, such as a police department, a fire department, or other first responder organizations. Alternatively, the devices may be distributed across multiple entities, such as collaborative teams from different public safety or service agencies. For example, some client devices 108 may belong to a police department, while others may be utilized by firefighters or emergency medical services within the same jurisdiction. While first responder scenarios provide a practical and illustrative use case, the described system is adaptable to a wide variety of electronic communication contexts, including enterprise environments, industrial facilities, and general consumer communication networks, showcasing its flexibility and broad applicability.

In general, it is to be understood that network addresses of client devices 108 may be registered with an application server 116 that has access to such network addresses. The types of network addresses may include, but are not limited to, email addresses, phone numbers, internet protocol (IP), uniform resource locators (URLs) or other types of network addresses that may be used to communicate with, and/or send alerts to, the client devices 108.

In the first responder context, application server 116 can be a Mission-Critical Push-to-Talk Application Server (MCPTT AS). Such an MCPTT AS is a specialized server that manages mission-critical communication services for first responders, including group and individual voice calls, messaging, and data transmission. It can provide reliable and secure communication under high-demand and emergency scenarios, as defined by the 3GPP mission-critical standards.

According to the context, application server 116 may be responsible for one or more of the following functions including:

### Session Management:

Establishing, maintaining, and terminating communication sessions, including one-to-one and group calls.
   Handling the dynamic addition or removal of participants during ongoing sessions.

### Floor Control:

Managing “push-to-talk” functionality to ensure that only one user speaks at a time in group communications.
Prioritizing participants based on roles or emergency needs (e.g., incident commanders).

### Interoperability:

Bridging communications between different devices 108 and other systems (not shown), such as radios, smartphones, and tablets.
Supporting integration with legacy Land Mobile Radio (LMR) systems for seamless hybrid operations.

### Broadcast and Alerts:

Enabling wide-area alerts or targeted messaging to specific groups or individuals, such as incident alerts to all devices in a particular jurisdiction.

### Quality of Service (QoS):

Prioritizing mission-critical traffic over other network activities, particularly during network congestion.

### Security:

Encrypting communications and ensuring authentication of participants.

Clock skew server 120 is provided in system 100 to mitigate challenges posed by unsynchronized clocks across devices 108, particularly where such devices 108 may not have access to servers 124 due to a variety of potential factors. For example, devices 108-4 and 108-5, as shown in FIG. 1, may be disconnected from network 104, rendering them unable to communicate with NTP servers 124. Alternatively, security restrictions or operational policies may prohibit certain client devices 108 from accessing NTP servers 124, even when they are connected to network 104. Clock skew server 120 and its effect on other client devices 108 will be explained in greater details below.

System 100 is broadly applicable across a wide range of protocols, particularly those requiring or benefiting from time synchronization between client devices 108. This includes, but is not limited to, identity-based encryption (IBE) protocols. One specific example of such a protocol, which is contemplated and emphasized in the present specification, is the MIKEY-SAKKE protocol. (See 3GPP TS 33.246-Security; Key management for MBS (Multimedia Broadcast/Multicast Service) and ETSI TS 103 523-3: “Electronic Signatures and Infrastructures (ESI); Identity-Based Cryptography; Part 3: Sakai-Kasahara Key Encryption (SAKKE). The contents of both of which are incorporated herein by reference.) Accordingly, to aid a person of ordinary skill in the art in understanding of the present teachings, this specification focuses on MIKEY-SAKKE as a representative example. However, it is to be understood that the principles and methods described herein extend beyond MIKEY-SAKKE to other secure communication protocols that similarly rely on accurate timing or clock synchronization for secure message validation and replay protection.

In sum, system 100 is designed to support client devices 108 in various operational scenarios. This includes devices 108 that are connected to the application server 116, either directly or indirectly via network 104, as well as devices 108 operating in a peer-to-peer mode. The system 100 enables devices 108 to securely exchange, for example, MIKEY-SAKKE messages and other time-sensitive information, even in environments where Network Time Protocol (NTP) synchronization (or another source of absolute time reference) is unavailable.

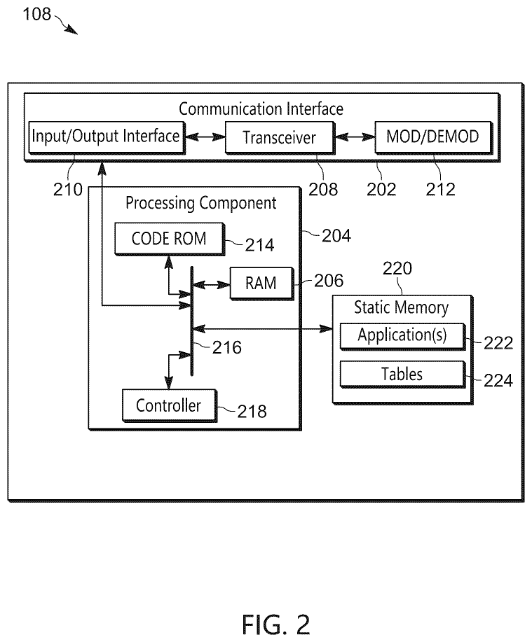

Attention is next directed to FIG. 2, which depicts a schematic block diagram of a non-limiting example of the architecture of client device 108.

As shown in FIG. 2, the client device 108 includes a communication interface 202 communicatively coupled to the common data and address bus 216 of the processing component 204. The processing component 204 may include the code Read Only Memory (ROM) 214 coupled to the common data and address bus 216 for storing data for initializing system components. The processing component 204 may further include the controller 218 coupled, by the common data and address bus 216, to the Random-Access Memory 206 and the static memory 220.

While not depicted, the client device 108 may include, and/or be communicatively coupled to, any suitable combination of input devices and/or output devices, which may include the microphone and/or a camera, a speaker, a display screen, a keyboard, and/or a pointing device, and the like.

The communication interface 202 may include one or more wired and/or wireless input/output (I/O) interfaces 210 that are configurable to communicate with other suitable components of the system 100.

For example, the communication interface 202 may include one or more transceivers 208 and/or wireless transceivers for communicating with other suitable components of the system 100. Hence, the one or more transceivers 208 may be adapted for communication with one or more communication links and/or communication networks (e.g. network 104, or a peer-to-peer link between two or more client devices 108) used to communicate with the other components of the system 100, including, but not limited to, the other. For example, the one or more transceivers 208 may be adapted for communication with one or more of the Internet, a digital mobile radio (DMR) network, a Project 25 (P25) network, a terrestrial trunked radio (TETRA) network, a Bluetooth network, a Wi-Fi network, for example operating in accordance with an IEEE 802.11 standard (e.g., 802.11a, 802.11b, 802.11g), an LTE (Long-Term Evolution) network and/or other types of GSM (Global System for Mobile communications) and/or 3GPP (3rd Generation Partnership Project) networks, a 5G network (e.g., a network architecture compliant with, for example, the 3GPP TS 23 specification series and/or a new radio (NR) air interface compliant with the 3GPP TS 38 specification series) standard), a Worldwide Interoperability for Microwave Access (WiMAX) network, for example operating in accordance with an IEEE 802.16 standard, and/or another similar type of wireless network. Hence, the one or more transceivers 208 may include, but are not limited to, a cell phone transceiver, a DMR transceiver, P25 transceiver, a TETRA transceiver, a 3GPP transceiver, an LTE transceiver, a GSM transceiver, a 5G transceiver, a Bluetooth transceiver, a Wi-Fi transceiver, a WiMAX transceiver, and/or another similar type of wireless transceiver configurable to communicate via a wireless radio network.

It is understood that while DMR transceivers, P25 transceivers, and TETRA transceivers may be particular to first responders, in some examples, the system 100 may be operated by a first responder entity (e.g., such as a police department, a fire department, an emergency medical services department, and the like), and hence such transceivers may be used for communications.

The communication interface 202 may further include one or more wireline transceivers 208, such as an Ethernet transceiver, a USB (Universal Serial Bus) transceiver, or similar transceiver configurable to communicate via a twisted pair wire, a coaxial cable, a fiber-optic link, or a similar physical connection to a wireline network. The transceiver 208 may also be coupled to a combined modulator/demodulator 212.

It is furthermore understood that when the communication interface 202 may include a plurality of transceivers 208, the client device 108 may select which of the plurality of transceivers 208 to use based on the aforementioned severity level.

In general, the communication interface 202 is designed to facilitate versatile communication capabilities. Communication interface 202 can establish connections over network 104, enabling communication with other system components such as application server 116, clock skew server 120, or other client devices 108. Alternatively, communication interface 202 is capable of direct device-to-device communication in a peer-to-peer mode, bypassing network 104 entirely. This peer-to-peer functionality is particularly valuable in scenarios where network 104 is unavailable, such as in remote areas, during infrastructure failures, or in highly secure environments where network access is restricted. By dynamically selecting between network-based communication and peer-to-peer communication, the communication interface 202 ensures consistent and reliable operation across a wide range of use cases and operational conditions, further enhancing the robustness and adaptability of system 100.

The controller 218 may include ports (e.g., hardware ports) for coupling to other suitable hardware components of the system 100.

The controller 218 may include one or more logic circuits, one or more processors, one or more microprocessors, one or more GPUs (Graphics Processing Units), one or more TPUs (Tensor Processing Units), and/or the controller 218 may include one or more ASICs (Application-Specific Integrated Circuits) and one or more FPGAs (Field-Programmable Gate Arrays), and/or another electronic device capable of executing the necessary functionalities. In some examples, the controller 218 and/or the client device 108 is not a generic controller and/or a generic device, but a device specifically configured to implement functionality for controlling alert transmission or secure communication. For example, in some examples, the client device 108 and/or the controller 218 specifically comprises a computer-executable engine configured to implement functionality for controlling alert transmission or performing other mission-critical operations such as cryptographic calculations or replay attack prevention.

The static memory 220 comprises a non-transitory machine readable medium that stores machine readable instructions to implement one or more programs or applications and/or program code. Example machine readable media include a non-volatile storage unit (e.g., Erasable Electronic Programmable Read Only Memory (“EEPROM”), Flash Memory) and/or a volatile storage unit (e.g., random-access memory (“RAM”)). In the example of FIG. 2, programming instructions (e.g., machine readable instructions) that implement the functionality of the client device 108 as described herein are maintained, persistently, at the memory 220 and used by the controller 218, which makes appropriate utilization of volatile storage during the execution of such programming instructions.

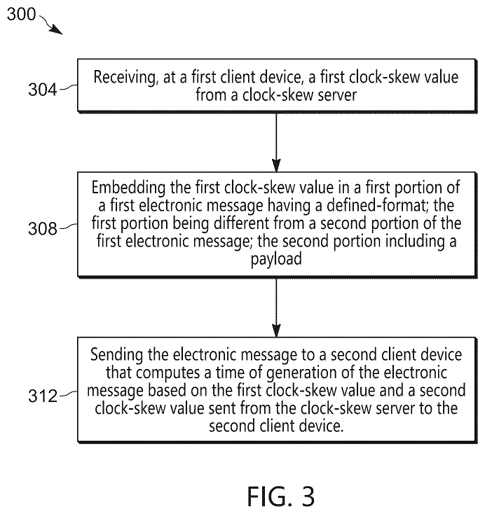

In particular, the memory 220 stores instructions and/or program code and/or a set of instructions corresponding to the at least one application 222 that, when executed by the controller 218, enables the controller 218 to implement functionality for controlling alert transmission, including but not limited to, the blocks of the method set forth in FIG. 3.

Put another way, the memory 220 may comprise a (e.g., non-transitory) computer-readable storage medium having stored thereon program instructions that, when executed by the controller 218, cause the controller 218 to perform a set of operations comprising the blocks of the method set forth in FIG. 3

The application 222 may include programmatic algorithms, and the like, to implement functionality as described herein. Alternatively, and/or in addition to programmatic algorithms, the application 222 may include one or more machine learning algorithms to implement functionality as described herein. In particular, such programmatic algorithms and/or machine learning algorithms may be used to determine a severity level and/or to select a set of other client devices to which to transmit an alert based on the severity level.

For example, the one or more machine learning algorithms may include, but are not limited to: a deep-learning based algorithm; a neural network; a generalized linear regression algorithm; a random forest algorithm; a support vector machine algorithm; a gradient boosting regression algorithm; a decision tree algorithm; a generalized additive model; evolutionary programming algorithms; Bayesian inference algorithms, reinforcement learning algorithms, and the like. Any suitable machine learning algorithm and/or deep learning algorithm and/or neural network is within the scope of present examples.

Attention is now directed to FIG. 3, which depicts a flowchart representative of a method 300 for communication between devices in the absence of time synchronization. The operations of the method 300 of FIG. 3 correspond to machine readable instructions that are executed by the controller 218 and/or the client device 108. In the illustrated example, the instructions represented by the blocks of FIG. 3 are stored at the memory 220 for example, as the application 222. The method 300 of FIG. 3 is one way in which the controller 218 and/or the client device 108 and/or the system 100 may be configured. Furthermore, the following discussion of the method 300 of FIG. 3 will lead to a further understanding of the system 100, and its various components.

The method 300 of FIG. 3 need not be performed in the exact sequence as shown and likewise various blocks may be performed in parallel rather than in sequence. Accordingly, the elements of method 300 are referred to herein as “blocks” rather than “steps”. The method 300 of FIG. 3 may be implemented on variations of the system 100 of FIG. 1, as well.

Block 304 comprises receiving, at a first client device, a first clock-skew value from a clock-skew server. This clock-skew value represents the time difference between the clock of the first client device and the clock maintained by the clock-skew server. While not required, it is contemplated that the first client device will also establish a cryptographic trust relationship with the clock-skew server, so that the received clock-skew value is verified for authenticity and integrity.

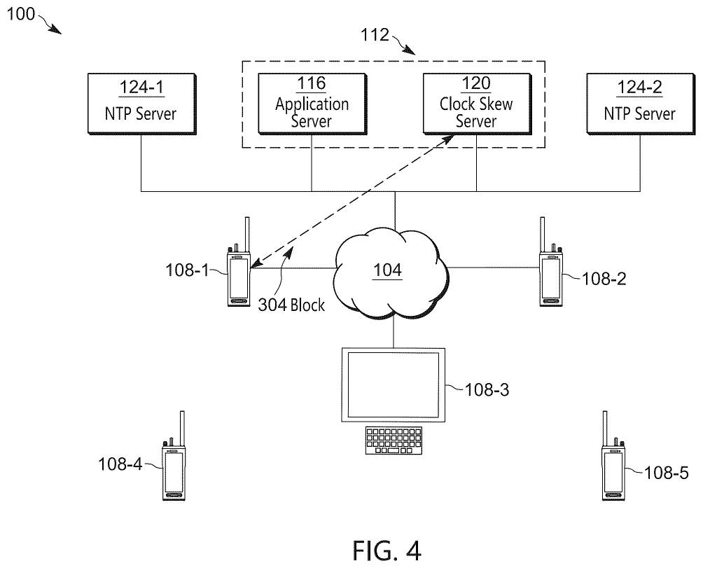

According to a specific example, block 404 can utilize secure communication protocols, such as the MIKEY-SAKKE identity-based encryption scheme, to protect the integrity of the clock-skew value during transmission. In relation to FIG. 4, block 304 can comprise device 108-1 communicating with clock skew server 120 via network 104 to obtain a cryptophaphically signed clock skew certificate from clock skew server 120.

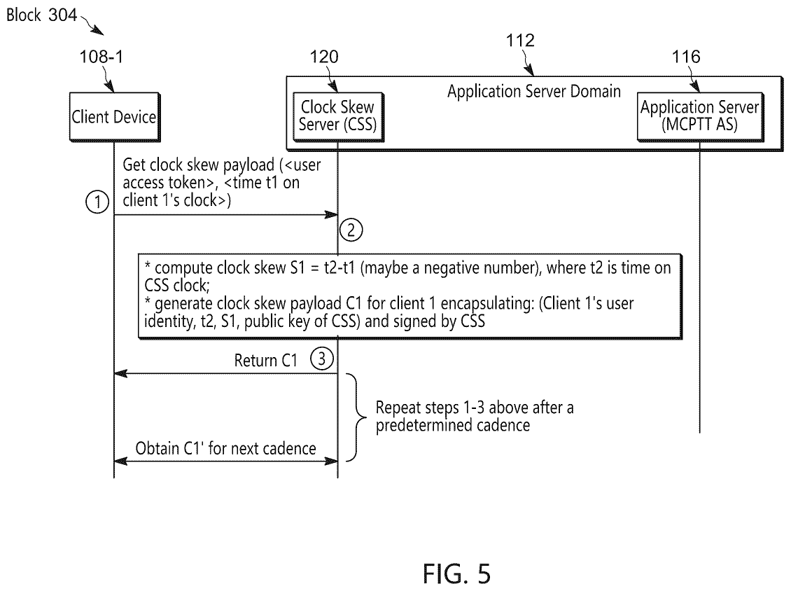

To elaborate, as depicted in the sequence diagram of FIG. 5, the process for block 404 begins when client device 108-1 initiates a request to the clock skew server 120 to obtain a clock-skew certificate. This request can include a user access token and a timestamp (t1) representing the time on the clock of client device 108-1 when the request is made. (It is to be understood that, in variants, the access token is optional—as the interaction can be unauthenticated in such variants.) The clock skew server 120 responds by calculating the clock-skew value (S1=t2−t1), where t2 is the time on the clock of clock skew server 120 when the request is processed. It is noted that S1 may be a negative value depending on the direction of the clock offset between the client and the server.

Following this calculation, the clock skew server 120 generates a clock-skew payload (referred to as C1), which encapsulates the following elements:

A. The identity of client device 108-1.

B. The calculated clock-skew value (S1).

C. A timestamp (t2) indicating the server's time when the payload was generated.

D. The public key of the clock skew server.

The clock-skew payload (C1) is cryptographically signed by the clock skew server 120 for authenticity and is subsequently returned to client device 108-1. Upon receipt, client 108-1 verifies the cryptographic signature on the payload (C1), confirming its validity. This verification Action establishes trust between the client device 108-1 and the clock skew server 120, mitigating risk of tampered or falsified data during transmission.

As shown in FIG. 5, this sequence of operations can be repeated periodically (e.g., after a predefined cadence) to ensure that the clock-skew value remains up-to-date, accounting for potential drift between the client device 108-1 and clock of server 120 over time. This repeated exchange allows the client to maintain an accurate reference for clock-skew correction, facilitating secure communication in scenarios where precise time synchronization via external sources, such as NTP servers, is unavailable.

The predefined cadence may refer to a fixed time interval or an adaptive time interval determined based on one or more of real-time clock drift measurements of devices 108, system performance requirements, and conditions of network 104. In one example, the predefined cadence is set to about thirty minutes to account for an expected maximum clock drift of about one millisecond per second while balancing the frequency of exchanges with network traffic constraints. In a more elaborate example, the predefined cadence can be an adaptive cadence, based on an ongoing measurement of drift measurements of each device 108 while they are connected to one of the NTP servers 124, or equivalent absolute time source, to gather historical data regarding the specific amount of clock drift for that client device 108 over period of time, which can be used to predict when clock drift may occur for that device 108 when access to NTP servers 124 is not available, thereby establishing a predefined time period for the predefined cadence. One or more machine learning operations can be performed, likewise, to ascertain such a predefined time period.

Block 308 comprises embedding the first clock-skew value in a first portion of a first electronic message having a defined format. The defined format complies with the chosen communication protocol, which in the present example is MIKEY-SAKKE but as noted, other supported encryption protocols may be chosen. The first portion, containing the clock-skew value, is distinct from a second portion of the electronic message, which contains the payload data. The first portion includes a timestamp to provide context for the clock-skew value. The embedding process may involve encrypting the first portion of the electronic message to ensure secure transmission to the recipient.

Block 312 comprises sending the electronic message to a recipient device. Upon receiving the message, the recipient device extracts the first clock-skew value from the first portion of the electronic message. The recipient device also receives a second clock-skew value directly from the clock-skew server 120 which represents the clock offset of the recipient device relative to the reference time of the clock-skew server 120. Using the first clock-skew value, the second clock-skew value, and the embedded timestamp, the recipient device computes the time of generation of the electronic message. This computation can be used by the recipient device to validate the authenticity and integrity of the electronic message, detect replay attacks, and process the payload securely, even in the absence of synchronized clocks.

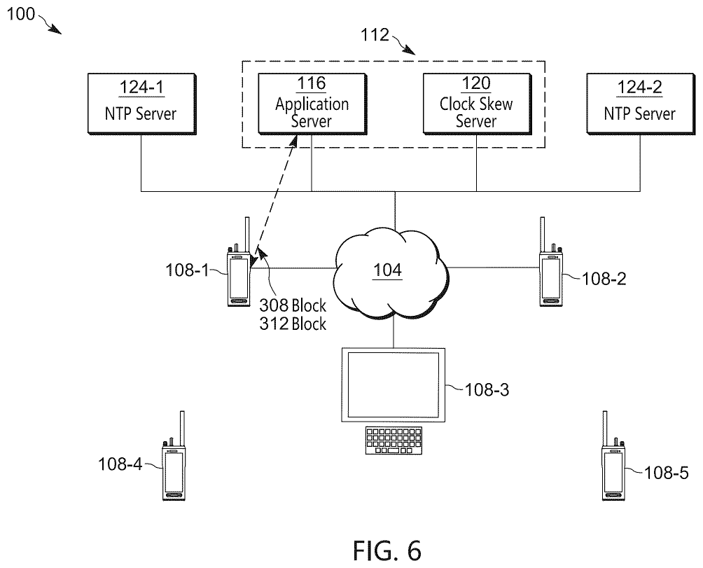

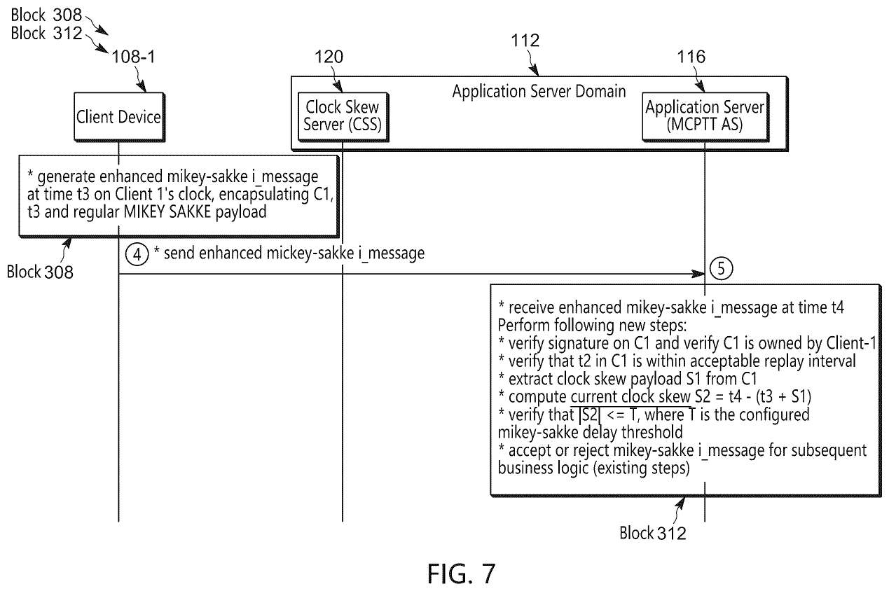

To elaborate on a first use case illustrated in FIGS. 6 and 7, the process described in blocks 308 and 312 involves a secure delivery of information from the client device 108-1 and the application server 116 through the clock-skew server 120. Thus, in this example application server 116 serves as the recipient device. As shown in FIG. 6, client device 108-1 communicates directly with the application server 116 via the network 104.

FIG. 7 provides a sequence diagram detailing the interactions between the components during this process. In block 308, client device 108-1 prepares an enhanced MIKEY-SAKKE message at time t3 on its local clock. The enhanced message includes:

A. Clock-Skew Value (C1): The clock-skew value received earlier from the clock-skew server 120 during the process described in block 304.

B. Timestamp (t3): The local clock time of client device 108-1 at the moment the message is generated.

C. Payload Data: The data to be transmitted to the application server 116, which is embedded in a distinct portion of the message to maintain separation from the clock-skew value and timestamp.

For secure transmission, the clock-skew value and timestamp are cryptographically signed, optionally encrypted, and embedded into the defined MIKEY-SAKKE i-message format.

At block 312, the enhanced MIKEY-SAKKE i-message is transmitted from client device 108-1 to the application server 116. Upon receiving the message, the application server performs the following actions:

A. Signature Verification: The application server 116 verifies the cryptographic signature on the clock-skew value (C1) and timestamp (t3) using the public key of the clock-skew server 120.

B. Clock-Skew Validation: The application server 116 performs the following:

### Verify Clock-Skew Value (C1):

The clock-skew value (C1) is verified using the public key of the clock-skew server 120 to verify origination from a trusted clock-skew server 120 and has not been tampered with.

### Verify Timestamp (t3):

The timestamp (t3), signed by the sending client device 108, is verified using the public key of the sending client device 108 to confirm its authenticity and ensure it reflects the actual local time when the message was generated.

### Validate Time Window:

The application server 116 compares the verified timestamp (t3) with its local clock, adjusted for the clock-skew value (C1), to confirm that the timestamp falls within an expected time window. If the validation succeeds, the message is considered timely; otherwise, it is rejected as delayed or malicious.

C. Payload Processing: If the signature verification and clock-skew validation succeed, the application server processes the payload contained in the second portion of the MIKEY-SAKKE i-message. This could involve decrypting the payload or using its contents to execute application-specific logic.

FIG. 7 demonstrates how the application server 116, acting as the recipient device in this example, utilizes the clock-skew value and timestamp to validate and process the message securely, thereby providing secure communication even in the absence of synchronization with an NTP server 124 or other reference clocks.

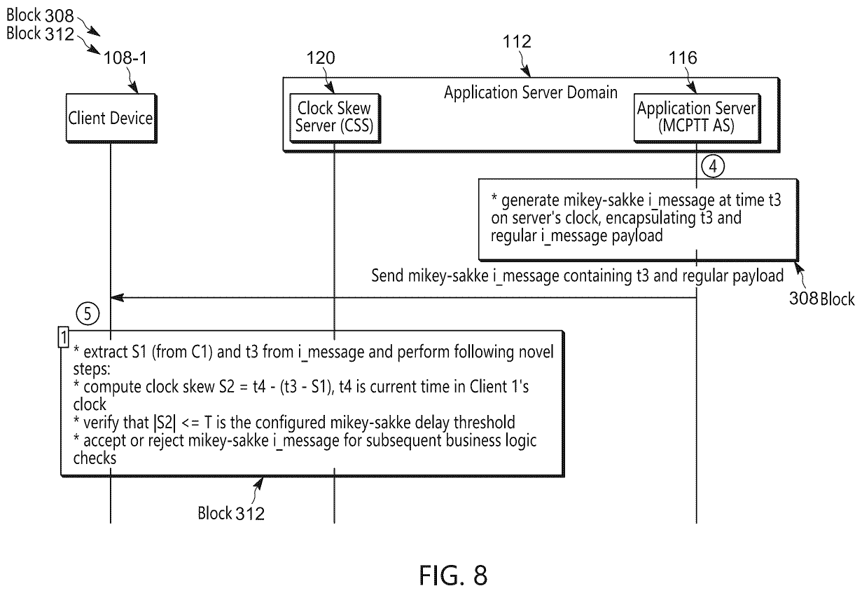

FIG. 8 illustrates a second use case for blocks 308 and 312, where the application server 116 sends an enhanced MIKEY-SAKKE i-message to client device 108-1. This scenario complements the first use case described in FIGS. 6 and 7, highlighting the bidirectional communication shown in FIG. 6. In this example, the application server 116 serves as the sending device, while client device 108-1 acts as the recipient device.

Block 308 in FIG. 7 involves the application server 116 preparing an enhanced MIKEY-SAKKE i-message at time t3 on its local clock. The i-message includes:

A. Clock-Skew Value (C1): The clock-skew value previously obtained by the application server 116 from the clock-skew server 120. This value represents the time difference between the clock of the application server and the clock maintained by the clock-skew server.

B. Timestamp (t3): The local clock time of the application server 116 when the i-message is prepared.

C. Payload Data: Application-specific data intended for client device 108-1, embedded in a distinct portion of the message separate from the clock-skew value and timestamp.

The clock-skew value, timestamp, and other relevant metadata can be cryptographically signed and optionally encrypted to preserve integrity and authenticity of the message during transit.

Block 312, as illustrated in FIG. 8, involves the transmission of an enhanced MIKEY-SAKKE i-message from the application server 116 to the client device 108-1. Upon receiving the i-message, client device 108-1 undertakes a series of operations designed to validate the message's integrity, ensure its timeliness, and process its payload securely.

### Action 1: Extraction of Embedded Values

The client device 108-1 extracts two critical pieces of information from the i-message:

Clock-Skew Value (C1): This value, provided earlier by the clock-skew server 120, represents the difference in time between the application server 116's clock and the clock-skew server's reference clock.

Timestamp (t3): This is the moment, according to the application server's local clock, when the i-message was generated.

These extracted values form the basis for subsequent verification and validation.

### Action 2: Computation of Adjusted Time (t4)

Using the extracted values, the client device computes the adjusted time t4, which represents the expected moment of message generation according to its own local clock. This computation is performed as follows:

$$S 2 = t 4 + C 2 - ( t 3 + C 1 )$$

Where:
t3 is the timestamp from the i-message,
C1 is the clock-skew value extracted from the i-message,
t4 is the client device's current time.

This Action ensures that the message generation time is translated into the local time context of client device 108-1.

### Action 3: Validation of Clock-Skew Threshold (S2)

The client device then verifies whether the computed value S2 lies within a predefined acceptable threshold T, which is configured to accommodate network and processing delays while guarding against replay attacks. If |S2|≤T, the message is deemed timely. Otherwise, the message is rejected as either delayed or potentially malicious. In sum at this Action 3, the message is either accepted or rejected for subsequent processing or business logic.

### Action 4: Signature Verification

The cryptographic signature on the clock-skew value (C1) and the timestamp (t3) is verified independently using their respective public keys. Specifically:

Clock-Skew Value (C1): The cryptographic signature on C1 is verified using the public key of the clock-skew server 120.

Timestamp (t3): The cryptographic signature on t3 is verified using the public key of the sending device (e.g., the client device 108-1 or the application server 116).

Both verifications are used for the message to proceed to payload processing.

### Action 5: Payload Processing

If both the clock-skew validation and signature verification are successful, the client device proceeds to process the payload contained in the i-message. This can include decrypting the payload and performing application-specific operations, such as updating internal data or triggering predefined workflows.

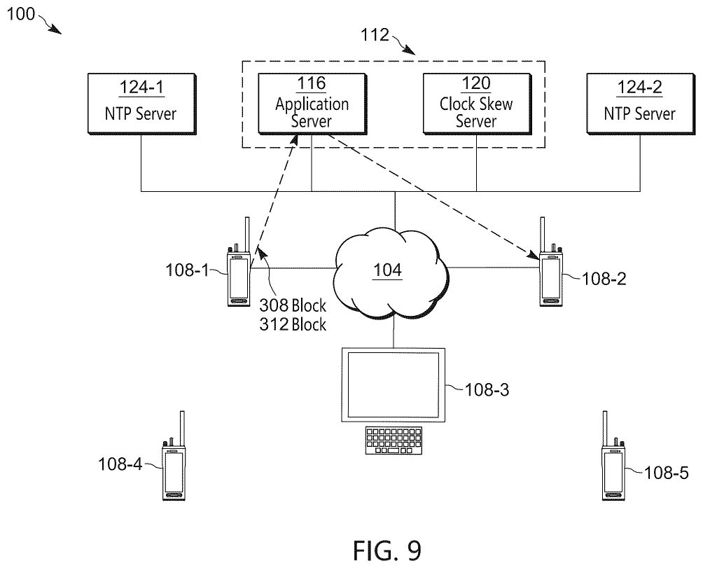

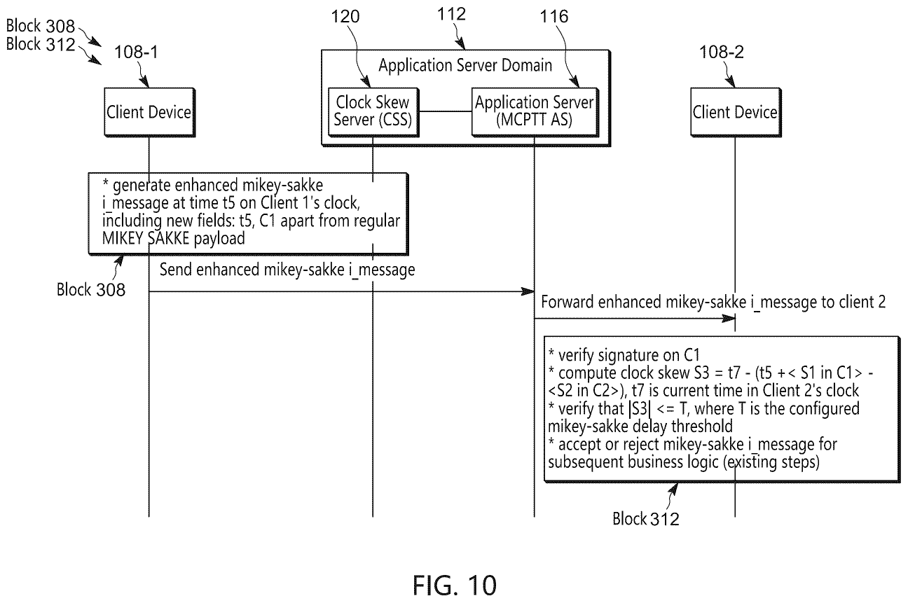

FIG. 9 and FIG. 10 illustrate a third use case for blocks 308 and 312, where the client device 108-1 sends a MIKEY-SAKKE i-message to client device 108-2 via application server 116.

Referring now to FIG. 10, in the third use case for blocks 308 and 312, client device 108-1 sends an enhanced MIKEY-SAKKE i-message to client device 108-2 via application server 116. This scenario extends the communication paradigm outlined in FIGS. 6 through 8, introducing an intermediary forwarding role for the application server 116.

In the context of FIG. 10, block 308 involves the preparation of an enhanced MIKEY-SAKKE i-message by client device 108-1 at time t5 on its local clock. The enhanced message incorporates the following elements:

Clock-Skew Value (C1): Obtained earlier by client device 108-1 from the clock-skew server 120, this value represents the time difference between the clock of client 108-1 and the reference clock of the clock-skew server 120.

Timestamp (t5): The local clock time of client device 108-1 when the i-message is generated.

Payload Data: As discussed earlier this is the specific information intended for client device 108-2, that is encapsulated in the message alongside cryptographic metadata such as the clock-skew value and timestamp.

The clock-skew value, timestamp, and payload data are cryptographically signed and optionally encrypted to safeguard the integrity and authenticity of the i-message during transmission.

Block 312 encompasses the transmission of the enhanced MIKEY-SAKKE i-message from client device 108-1 to application server 116. Upon receiving the message, application server 116 performs the following operations as per FIG. 10:

### Action 1: Signature Verification:

Application server 116 verifies the cryptographic signature on the clock-skew value (C1) using the public key of the clock-skew server 120 and verifies the timestamp (t5) using the public key of client device 108-1.

### Action 2: Forwarding Preparation:

After validating the authenticity of the received message, application server 116 prepares to forward the i-message to client device 108-2. In this Action, the server may embed its own clock-skew value (C2) and current timestamp (t6) to facilitate time synchronization for the next leg of the communication. Thus application server 116 embeds its own clock-skew value C2 and timestamp t6 as additional cryptographic metadata while preserving the original timestamp t5 and clock-skew value C1 for end-to-end synchronization.

Note certain relationships relevant to forwarding preparation as follows:

Time at client device 108-1 (t5): The moment when client device 108-1 generates the enhanced MIKEY-SAKKE i-message.

Expected Time at Application Server 116 (t6): Adjusted for clock skew S1 (as noted in C1), this is calculated as: t6=t5+S1

Expected Time at Client Device 108-2, adjusted for clock skew S2 (as noted in C2), this is calculated as: t6−S2=(t5+S1−S2)

### Action 3: Message Forwarding:

Application server 116 transmits the updated enhanced MIKEY-SAKKE i-message to client device 108-2, incorporating the newly calculated timestamp and clock-skew value for end-to-end synchronization.

Upon receiving the forwarded i-message, client device 108-2 performs the following Actions:

### Action 4: Signature Verification:

Client device 108-2 verifies the cryptographic signature on the embedded clock-skew value (C1) using the public key of the clock-skew server 120 and verifies the timestamp (t5) using the public key of client device 108-1.

### Action 5: Clock-Skew Validation:

Client device 108-2 computes an adjusted timestamp (t7) using the following equation:

$$S 3 = t 7 - ( t 5 + ( S 1 - S 2 ) )$$

Where:
a. S3 quantifies the message's timeliness as perceived by client device 108-2 and forms the basis for detecting replay attacks or other timing anomalies.
b. S1 is embedded in C1 and S2 is embedded in C2.
c. t7 is the current time on local clock of client device 108-2.

Client device 108-2 evaluates whether the computed value S3 lies within a predefined acceptable threshold T. If |S3|≤T, the i_message is considered valid and timely; otherwise, it is rejected as delayed or malicious.

### Action 6: Payload Processing:

If the message passes both signature verification and clock-skew validation, client device 108-2 proceeds to process the payload contained in the i-message. This may involve decrypting the payload and executing application-specific logic.

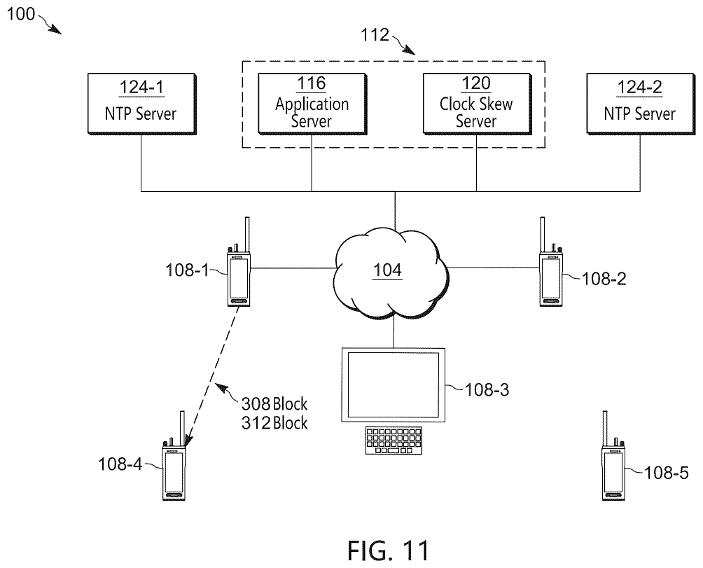

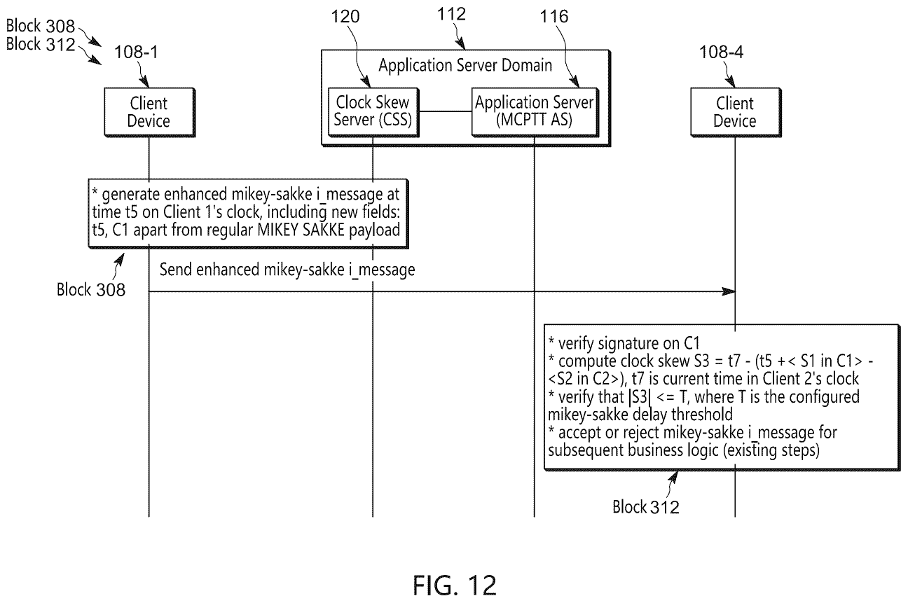

FIG. 11 and FIG. 12 illustrate a fourth use case for blocks 308 and 312, where the client device 108-1 sends a MIKEY-SAKKE i-message to client device 108-4 directly, in a peer-to-peer mode.

Referring now to FIG. 12, in the fourth use case for blocks 308 and 312, client device 108-1 sends an enhanced MIKEY-SAKKE i-message directly to client device 108-4, in a peer-to-peer mode.

Block 308 comprises the preparation of an enhanced MIKEY-SAKKE i-message by client device 108-1 at time t5 as derived from the local clock on client device 108-1. This message is prepared as follows:

Clock-Skew Value (C1): Obtained earlier by client device 108-1 from the clock-skew server 120, this value represents the time difference between the clock of client device 108-1 and the reference clock of the clock-skew server 120.

Timestamp (t5): The local clock time of client device 108-1 at the moment the message is generated.

Payload Data: The application-specific information intended for client device 108-4, encapsulated in the message alongside cryptographic metadata, including the clock-skew value and timestamp.

The clock-skew value, timestamp, and payload data are cryptographically signed and optionally encrypted to preserve the integrity and authenticity of the message during transmission.

Block 312 involves the transmission of the enhanced MIKEY-SAKKE i-message from client device 108-1 directly to client device 108-4. Upon receiving the message, client device 108-4 performs the following actions:

### Action 1: Signature Verification:

Client device 108-4 verifies the cryptographic signature on the clock-skew value (C1) using the public key of the clock-skew server 120 and timestamp (t5) using the public key of client device 108-4.

### Action 2: Clock-Skew Validation:

Client device 108-4 computes the adjusted delay (S3) using the following formula:

$$S 3 = ( t 7 + S 2 ) - ( t 5 + S 1 )$$

Where:

t5 is the timestamp from the i-message.

S1 is the clock-skew value embedded in C1.

S2 is the clock-skew value specific to client device 108-4, previously obtained from the clock-skew server 120.

t7 is the current local time on the clock of client device 108-4.

Client device 108-4 evaluates whether the computed value S3 falls within a predefined acceptable threshold T. If |S3|≤T, the i-message is deemed valid and timely; otherwise, it is rejected as delayed or malicious.

### Action 3: Payload Processing:

If the signature verification and clock-skew validation succeed, client device 108-4 proceeds to process the payload contained in the i-message. This may involve decrypting the payload and executing application-specific logic.

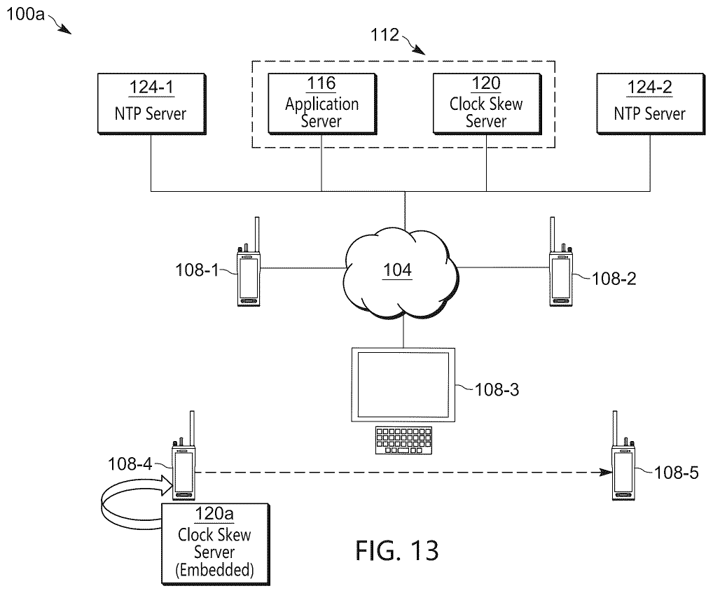

It should now be understood that variations, combinations and subsets of these embodiments are contemplated. For example, FIG. 13 shows a variation on system 100 labelled as system 100a. Like elements bear like references, except varied elements include a suffix “a”. Notably, in system 100a, device 108-4a is a variant on device 108-4, where a clock skew server 120a is embedded directly into the device 108-4a. In this way, secure messages can be sent in a pure peer-to-peer environment between device 108-4a and device 108-5, with device 108-4a providing clock-skew services to device 108-5 and for itself, device 108-4a. In this variant, device 108-4a is shown as being completely disconnected from network 104, but it is contemplated that from time to time a connection between device 108-4a may periodically connected to network 104 so that clock skew server 120a can obtain an absolute time reference from, for example, NTP servers 124 in order to establish a local clock skew at device 108-4a and for device 108-5. Alternatively, where no access to network 104 is possible, then clock skew server 120a may manage a relative skew between device 108-4a and device 108-5.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot control transmission of data, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions and/or program code (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions and/or program code, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method comprising:
receiving, at a first client device, a first clock-skew value from a clock-skew server;
embedding the first clock-skew value in a first portion of a first electronic message having a defined-format; the first portion being different from a second portion of the first electronic message; the second portion including a payload; and,
sending the electronic message to a recipient device that computes a time of generation of the electronic message based on the first clock-skew value and a second clock-skew value sent from the clock-skew server to the recipient device.

2. The method of claim 1 wherein the defined-format is the i_message format based on Multimedia Internet Keying-Sakai-Kasahara Key Encryption (MIKEY-SAKKE).

3. The method of claim 1 wherein the recipient device is one of an application server, a second client device, and the first client device.

4. The method of claim 1 further comprising, prior to sending, encrypting the first electronic message using at least one of a session key and a public/private key pair.

5. The method of claim 1 wherein the clock-skew server is remotely hosted from the first client device.

6. The method of claim 4 wherein the clock-skew server is a third client device and the method further comprising sending at least one additional defined-format electronic message embedding an additional clock-skew value generated by the third client device; the at least one additional defined-format electronic message being sent to one or more of the client devices.

7. The method of claim 4 wherein the clock-skew server is hosted within an application server domain remote to the first client device and the recipient device.

8. The method of claim 6 further comprising sending the electronic message to a third client device that computes the time of generation of the electronic message based on the first clock-skew value and a third clock-skew value sent from the clock-skew server to the third client device.

9. The method of claim 1 wherein the clock-skew server is integrated into to the first client device.

10. The method of claim 1 wherein the time of generation is used by the recipient device to determine a handling-protocol for the first electronic message.

11. The method of claim 10 wherein the handling protocol includes at least one of: a) detecting a replay attack and rejecting the first electronic message, and b) verifying that the first electronic message is valid.

12. The method of claim 1 wherein the receiving, embedding and sending occurs with call flows defined by the 3GPP standard.

13. A client device comprising a processor and a memory storing programming instructions that configure the processor to:
receive a first clock-skew value from a clock-skew server;
embed the first clock-skew value in a first portion of a first electronic message, the first portion being distinct from a second portion of the first electronic message, wherein the second portion includes a payload; and
send the electronic message to a recipient device, wherein the recipient device is configured to compute a time of generation of the electronic message based on the first clock-skew value and a second clock-skew value received from the clock-skew server.

14. The method of claim 1 wherein the defined-format is the i_message format based on Multimedia Internet Keying-Sakai-Kasahara Key Encryption (MIKEY-SAKKE).

15. The method of claim 1 wherein the recipient device is one of an application server, a second client device, and the first client device.

16. The method of claim 1 further comprising, prior to sending, encrypting the first electronic message using at least one of a session key and a public/private key pair.

17. A method of transmitting a cryptographic key securely from a first client device to a first recipient device using a first electronic message prepared by the first client device according to MIKEY-SAKKE identity based encryption scheme comprising:
i) enabling, prior to transmitting the first electronic message, both the first client device and the first recipient device to cryptographically trust a clock skew service;
ii) obtaining, prior to transmitting the first electronic message, a first clock skew certificate from the clock skew service by the first client device, the first clock skew certificate being cryptographically signed by the clock skew service and containing at least the identity of the first client device and a first clock-skew value representing the difference in time between the first client device and the clock-skew service;
iii) obtaining, prior to transmitting the first electronic message, a second clock skew certificate from the clock skew service by the first recipient device, the second clock skew certificate being cryptographically signed by the clock skew service and containing at least the identity of the first recipient device, a second clock-skew value representing the difference in time between the first recipient device and the clock-skew service;
iv) embedding, prior to transmitting the first electronic message, the first clock skew certificate into the first electronic message by the first client device along with a first timestamp representing the clock time within the first client device;
v) receiving, by the first recipient device, the first electronic message transmitted by the first client device;
vi) extracting the first clock-skew value from the first electronic message, by the first recipient, after cryptographically verifying the authenticity of the first clock skew certificate contained in the first electronic message; and
vii) computing, by the first recipient device, the time of preparation of the first electronic message with reference to the clock time within the first recipient device, using the first clock-skew value, the second clock-skew value and the first timestamp.

18. The method of claim 17, wherein the first recipient device is a second client device having a substantially identical architecture to the first client device.

19. The method of claim 17, wherein the first recipient device is an application server providing a service to the first client device.

20. The method of claim 17, wherein the clock skew service is provided by a third client device having a substantially identical architecture to the first client device.
